(19) United States
(12) Patent Application Publication
(10) Pub. No.: US 2002/0029194 A1
(43) Pub. Date: Mar. 7, 2002

(54) System and method of managing financial transactions over an electronic network

(76) Inventors: Richard Lewis, New York, NY (US); Gary S. Miller, Lawrence, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/948,247

(22) Filed: Sep. 7, 2001

Related U.S. Application Data
(63) Continuation-in-part of application No. 09/657,019, filed on Sep. 7, 2000.

(51) Int. Cl. G06F 17/60

(52) U.S. Cl. 705/39; 705/40

(57) ABSTRACT

A method and system for managing transactions over an electronic network accepts input of all transaction, participant and financial information and creates a secure, participant personalized and transaction-customized graphical user transaction interface, where participants can view, update and complete transaction details and documents over the electronic network. A database stores laws, requirements and customs for documents and procedures of all jurisdictions and potential participants. In view of the input information regarding the transaction and all rules, even overlapping and conflicting, relevant to the transaction details, the system automatically creates the interface and documents unique to the transaction, in the proper format and with the correct information. Transaction documents can also be uploaded from external sources. The system automatically calculates all required payments, arranges for the electronic transfer of funds upon input by the participants of final authorization, accompanied by digital verification, and creates audit records of the final transaction details.

### CROSS-REFERENCE TO RELATED APPLICATION

This application is a continuation-in-part of U.S. patent application Ser. No. 09/657,019, filed Sep. 7, 2000.

### BACKGROUND OF THE INVENTION

This invention relates to the provision of services that allow companies to manage over the Internet a business-critical contract-based financial transaction or a transaction involving transfer of ownership interests in a property. More particularly, this invention relates to an Internet based or other on-line- or electronic network-based system that allows financial transactions, including those for high-value items such as real estate, to be managed over an electronic network.

Contract-based transactions involving transfer of ownership of property, particularly those of high net worth items, are complicated and inefficient, since they are typically done manually, are fragmented in their procedures, and are typically paper-based. Each transaction may have many participants, each of which has its own needs and requirements. Multiple payments must be made among the participants, and the high value of the item or property being transferred requires that these payments be certified. Moreover, each jurisdiction may have different legal regulations in order to prevent fraud, such that these transactions are not uniform from jurisdiction to jurisdiction.

Real estate transactions, the conclusions of which are known generally as “closings”, are a perfect example of such complicated transactions. A typical residential real estate transaction in New York State, from the initial agreement between the buyer and seller through the closing, proceeds as follows. Once a purchaser and seller agree on a purchase price, the purchaser sends a down payment check, along with an executed contract of sale, to the seller's attorney. The seller's attorney sets up a unique escrow account with a bank and deposits the down payment check. The purchaser's attorney orders a title report from an agent of a title company (a “title agent”) ). The title report lists any outstanding mortgages, the status of tax payments on the property, and any judgments and liens against the property that the seller must satisfy at closing.

Generally, the seller will desire to redirect portions of the purchase price to pay off any outstanding mortgages, his real estate broker, his attorney, etc. In the days leading up to the closing, the seller's attorney will notify the purchaser's attorney of the amounts of the payments to be made, the payees of those payments, and any requirements for certification of checks payable at closing. The purchaser's attorney will convey the payment information to the lender's attorney and to the purchaser in order for these amounts to be made payable from the new loan.

Prior to closing, the seller's attorney transfers funds from the unique escrow account to a master escrow account to issue checks. The lender wires funds into the lender's attorney's account, on or the day before the day of the closing, so that the lender's attorney can write checks against them. Some of the checks must be certified prior to closing. The purchaser will bring to the closing one or more certified checks for the balance of the purchase price and closing costs.

At the closing, the parties review and execute various documents. The parties also make final adjustments to the purchase price to account for tax per diems, utilities and damages. The purchaser tenders the purchase price, as adjusted, to the seller. The purchase price amount is drawn from three sources: the seller's attorney's escrow account (the amount of the down payment), the lender's attorney account (the amount of the mortgage) and the purchaser's account (the balance of the purchase price). Many of the checks will be certified and will be made payable to parties as directed by the seller. The purchaser, the seller and the lender also pay the title agent for title insurance, transfer taxes and mortgage recording fees, usually via non-certified checks. In addition, the bank attorney and title closer photocopy all checks and documents for all attendees. The bank attorney also completes government-or municipality-mandated forms, such as a HUD-1 form, detailing the closing. The title closer, a representative of the title agent, examines picture IDs of the purchaser and seller in order to confirm identity. A typical closing takes approximately two to three hours.

After the closing, the title closer delivers the check(s) payable to the seller's lender (the pay-off bank) or any other party being paid off. The seller pays the title closer a “pick-up” fee for each pay-off, and the title closer takes the pay-off checks and letters to the previous mortgage holder and liens holders. The title agent transmits the mortgage and deed to the appropriate county clerk for recording, along with the recording taxes and transfer taxes to the appropriate state agency. The title agent remits quarterly or monthly payments to the title company a percentage of the title premium paid at closing.

In some states, parties have multiple roles at the closing, in addition to those discussed above. For instance, in the State of New Jersey, the borrower's attorney also represents the lender and the title agent at closing. Moreover, the likelihood of fraud is increased, as there are fewer checks and balances at the closing of a transaction in these states.

Clearly, the process of closing a real estate transaction, as well as any transaction involving transfer of ownership interests, especially those involving high value items, can be a long and arduous task for all parties involved. Bookkeeping is complicated and hard to follow. There are numerous checks, from different sources and with different payees. Many documents are involved, and copies must be distributed to various parties. Thus, mistakes can be made easily, and those mistakes can be very costly, in terms of both the time and money involved.

Some states, known as escrow states, such as Arizona, California, Florida, Hawaii, Oregon and Washington, do not have a closing event at which parties exchange documents and money. The escrow agent, which is usually the title company or title agent, meets with the parties individually, has all the documents executed and receives and holds all money. Generally, the purchaser, the seller and the lender will not have attorneys. However, payments are generally made in the same way as in states that have closings, and thus the complications therein have not necessarily been reduced.

The traditional process of real estate transactions, or of transaction of any high-value property item, creates many opportunities for fraud. For example, attorneys and title agents who hold funds in escrow may abscond with funds prior to closing of the transaction or may fail to forward recording fees, escrowed tax payments or pay-off monies. Also, sellers, or borrowers, in the case of a refinance, may take advantage of the time lag in recording of documents and may make multiple sales or mortgages of a single property. Similarly, sellers may draw down on a credit-line mortgage during the time lag between closing and the receipt of a pay-off by the old lender. In some cases, the seller may not even actually own the property being sold. In addition, checks may be written against insufficient funds or their certifications may be forged. This is especially troublesome for title companies or agents who are at risk for the various state and county recording fees. Furthermore, because of the lack of an objective standard of due diligence for fraud protection, the title agent must comply with the negligence standard set by the title company and with the title company's watch list (list of parties suspected of fraud), which is maintained manually. Also, in those states in which parties have multiple roles at the closing, the likelihood of fraud is further increased, as there are fewer checks and balances at a closing.

Further, there are many other inherent disadvantages in the traditional process of real estate transactions or of transaction of any high-value property item. For example, because funds may not be received by the pay-off bank or others involved in a transaction until a day or two after the closing of the transaction, sellers may not receive good funds on the day of closing, and pay-off amounts may have to include two to four day's per diem interest in order to cover interest charges during the time of transmittal of the pay-off check. Moreover, sellers often have to incur a “pick-up” fee per pay-off. Also, lenders and attorneys may have complicated bookkeeping and reconciliation of checks, escrow accounts and pay-offs, and the purchaser/borrower cannot easily calculate all obligations prior to closing. Furthermore, because there is no way to ensure availability of funds transferred by check other than certification of the check, all checks typically have to be certified, and purchasers are forced to incur these check certification fees. Even worse, the certified checks may be lost or stolen. Also, because attorneys generally charge a flat fee per closing, closings that take more time result in lost income opportunities for attorneys. In addition, lenders and title companies have little or no real-time control over their agents.

Naturally, many of these opportunities for fraud and inherent disadvantages also exist in transactions involving high net worth items of property other than real estate.

Accordingly, it is one object of the invention to provide a system that streamlines the process of completing the contract-based transaction of a high-valued item and reduces the chances of fraud.

It is another object of the invention to provide a system that allows for a fast and checkfree closing of financial transactions with easy bookkeeping.

It is a further object of the invention to provide a web-based service that provides a neutral fraud-protection platform for financial transactions, especially those involving property, and automates the slow and paper intensive process of concluding such transactions.

It is yet another object of the invention to provide a system for concluding financial, in particular real estate, transactions that does not require any hardware or software beyond Web access and an Internet browser.

It is still another object of the invention to provide a web-based system for concluding financial, in particular real estate, transactions that will reduce closing expenses yet allow all participants in the current closing process to retain their roles and benefit from the service.

It is still a further object of the invention to enable businesses and individuals to exchange information and finalize financial transactions securely over the Internet through an environment that facilitates effective, secure collaboration among transaction participants and efficient execution of transactions, deals and legal processes.

It is yet a further object of the invention to enable businesses and individuals to exchange information and finalize financial transactions securely over the Internet through an environment that is personalized to the transaction participants and the transactions.

It is an even further object of the invention to enable creation of a detailed electronic audit trail of a financial transaction and to enable appropriate parties to review that audit trail before and after closing of the transaction in order to ensure and document that each required step in the transaction was in fact taken in the proper way.

### SUMMARY OF THE INVENTION

These and other objects of the invention are accomplished by providing a method and system for managing, over an electronic network, transactions involving a transfer of ownership interests, particularly those of high-value property items. Participants in the transaction register with the system via an electronic network connection, e.g., the Internet, and enter all transaction, participant, banking and financial information or transfer this information from elsewhere in the system or from an outside source. All sources of funds are identified on the system. A secure on-line transaction electronic graphical user interface or “space,” which is a personalized site for the participants and the transaction, is created where all registered participants can view, update and complete the details of a particular transaction over an electronic network.

The system contains a database of information regarding the laws and requirements of various jurisdictions and localities relating to such transactions, the habits or requirements of professionals and authorities capable of effectuating the transaction in those jurisdictions and localities, and the specific document formats or templates used by those jurisdictions and localities and by professionals and authorities. The database contains information regarding all the participants, documents, payments, etc., that are required or even preferred for various transactions. Based upon a correlation, concatenation or union of all the input information regarding the transaction in light of the laws, requirements and habits for the relevant locality or jurisdiction stored in the database, the system is preferably able to create all documents for the transaction, in the proper and desired format and with the correct information. Alternatively, the documents can be uploaded from participants, a jurisdiction or locality, or from another external source. The system preferably stores all documents and makes them available to all participants, according to their restrictions, for viewing and updating at any time.

In order to prevent fraud, verifications and security checks are performed automatically on the participants and on any information that is input. Based upon information stored in the database regarding all relevant charges, taxes and payments that must be made, as defined by the specific transaction as well as the rules and regulations of the jurisdictions, localities or participants or by the habits and practices of the professionals and participants involved in the transaction, as well as any other required payments, the system preferably automatically calculates all payments and expenses that must be made. The system also preferably arranges for the electronic transfer of funds in accordance with these payments, using the payment information input by the participants. Of course, these payments are not made until approval for the transaction is given, as discussed below.

On the date selected to complete the transaction, all participants gather in one physical location or virtually via an electronic network, e.g., by video conferencing. Alternatively, the participants may choose not to gather together but instead to each take their actions on-line, separately and at different times, such as by logging into the secure electronic interface for the particular transaction. The participants review the details and documents of the transaction, including all calculations and government-required forms, sign all documents, preferably digitally, and input their final on-line authorization of the closing transactions. The system can create audit records for the participants to view prior to giving their approval to the transaction.

Upon approval of the transaction, each participant gives his approval accompanied by some verification method, such as with a digital signature or biometrics, such as a digital fingerprint or voice identification, or the like. Once all the necessary approvals have been obtained, the transaction is finalized by the transfer of funds to the appropriate accounts, using an electronic payment initiator, which handles the transfer of funds for immediate availability. The clearing bank makes all payments via secure electronic funds transfers to the pay-off bank, the seller, and the various localities for recording fees and transfer taxes. Electronic funds transfers or credit card payments are processed for expenses such as utilities, title company and agent fees, and real estate broker fees. Payment details are recorded, and all required reports and forms are generated. There are no post-closing requirements of any party other than the transmittal of documents. The system can also create audit records for the participants to view with regard to the final details of the transaction that has occurred.

It should be noted that the system's process of closing transactions could vary from jurisdiction to jurisdiction and from closing to closing. This is because each jurisdiction, such as states, counties and villages may have its own rules, requirements, documents and forms for completing a real estate or other transaction. Similarly, each of the various the professionals and authorities who are authorized to carry out those transactions, such as lenders, title underwriters and attorneys, as well as each of the various participants of the transaction in each of those jurisdictions, may have its own habits, customs, requirements, documents and forms for completing a real estate or other transaction. In order to consider and accommodate the multitude of overlapping and intersecting habits, customs, documents, forms, rules and requirements, the system is programmed to take into account all the applicable and relevant rules for the given conditions and circumstances of the transactions. Once the system accesses all of the rules and requirements applicable to a particular transaction, which are identified by recognizing the given conditions and circumstances of the transaction, including the jurisdictions and participants, the system presents a customized secure on-line transaction space, or electronic graphical user interface, that is specific for the particular transaction, access-limited to the participants of the transaction and creates documents unique to that transaction. Moreover, the system is a learning system, in that it can generate new rules for future transactions by analyzing historical transactions and comparing variables.

As a result of using this system, opportunity for, and presence of, fraud is dramatically reduced. For example, the attorneys or title agents are not entrusted with funds, since all recording fees, escrowed tax payments and pay-off monies are forwarded electronically for immediate availability, so the attorneys or title agents cannot abscond with any money. In addition, a seller, or borrower in the case of a refinance, cannot make multiple sales or mortgages of a single property, since only one on-line transaction space can be opened at a time for a specific property. A seller also cannot draw down on a credit-line mortgage during the lag in time between closing and the receipt of a pay-off by the previous lender and cannot sell property that is not owned by him. Furthermore, the title company watch list is checked automatically on line before the closing to ensure due diligence in protecting against fraud.

There are other advantages to using the system of the current invention. For example, because the seller, purchaser, borrower and all other participants can easily calculate all obligations prior to closing, there are no surprises at the closing of the transaction. The pay-off bank, the seller and any others, including the title companies, receive good funds at closing, thereby eliminating time that had been spent waiting for checks to clear. There are no delays on pay-offs and no extra interest charges, and there is no pick-up fee charged to the seller. The purchaser can use credit cards or electronic funds transfers for some expenses and thereby avoid having to pay check certification fees or avoid worrying about potentially misplacing or destroying the certified checks. Bookkeeping and reconciliation of checks, escrow accounts and pay-offs are simplified and automated. Also, closings of transaction take less time, thereby saving time-based attorney and title agent fees for the participants and allowing for more income opportunities by attorneys and title agents. In addition, lenders and title companies have the ability to monitor their agents in real time.

Furthermore, the system could have other value-added services such as a closed and secure network of real estate professionals. This provides profitable opportunities for sale of data, provision of digital certificates and services to its proprietary network of real estate professionals. The system could have transaction closings over an electronic network, including the use of digital certificates to authenticate documents. Where possible, the system will electronically forward the mortgage and deed to the appropriate county clerks for electronic registration of title. The system could also have the most up-to-date register of pending and closed real estate or other property transactions available in the nation, which information could be critical to contractors, tax certiorari professionals, appliance manufacturers, etc. Further, the system could maintain full records of all transactions including images of all documents for the selling of historical data.

Because the system will provide for immediate available funds through governmentauthorized electronic funds transfer agents, the title insurance companies will receive a substantial measure of fraud protection. With the addition of a digital picture and signature and biometric information, such as a fingerprinting module, parties can be almost completely protected from potential fraud.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 is a hardware diagram for one embodiment of a system architecture according to the present invention;

FIG. 2 shows a first embodiment of the logical software architecture of the system of the present invention;

FIG. 3 shows an alternative embodiment of the logical software architecture of the system of the current invention;

FIG. 4 is a flowchart of a registration process according to the present invention;

FIG. 5 is a flowchart of the identity verification portion of the registration process in FIG. 1;

FIG. 6 is a flowchart of steps followed by a registrant of the process of FIG. 1 to activate an account;

FIG. 7 is a flowchart of a process of updating registration information;

FIG. 8 is a flowchart of a process of generating a bank-approved electronic funds transfer authorization;

FIG. 9 is a flowchart of a process of creating a new transaction on the system of the present invention; and

FIG. 10 is a flowchart of a process of populating a participant in a transaction according to the present invention.

### DETAILED DESCRIPTION OF THE INVENTION

The system of the present invention allows companies to manage business-critical contract-based financial transactions over an electronic communications network, such as the Internet. The system preferably integrates proprietary applications with secure hosting, redundant back up, security and customer support to provide comprehensive and easily accessed outsourced solutions. The system enables businesses and individuals to securely exchange information and finalize financial transactions that involve a transfer of ownership interests over an electronic communications network through an environment that facilitates effective, secure collaboration among transaction participants and efficient execution of transactions and legal processes.

The present invention can be implemented also on a private electronic network within a large corporation, and nothing in the invention limits its application to a public network, such as the Internet. To that end, accessing and using the system preferably requires no hardware or software beyond Web access and an Internet browser.

Preferably, however, the system is a web-based service providing a neutral fraudprotection platform and automating the slow process of paper-intensive manual transactions. In one embodiment, an independent entity, preferably a for-profit company, owns the system and handles all administrative and managerial duties tied to operating the system. The company may receive a nominal fee per transaction from the parties involved. However, all participants, such as lawyers, banks, title companies, etc., will retain their roles and benefit by using the service.

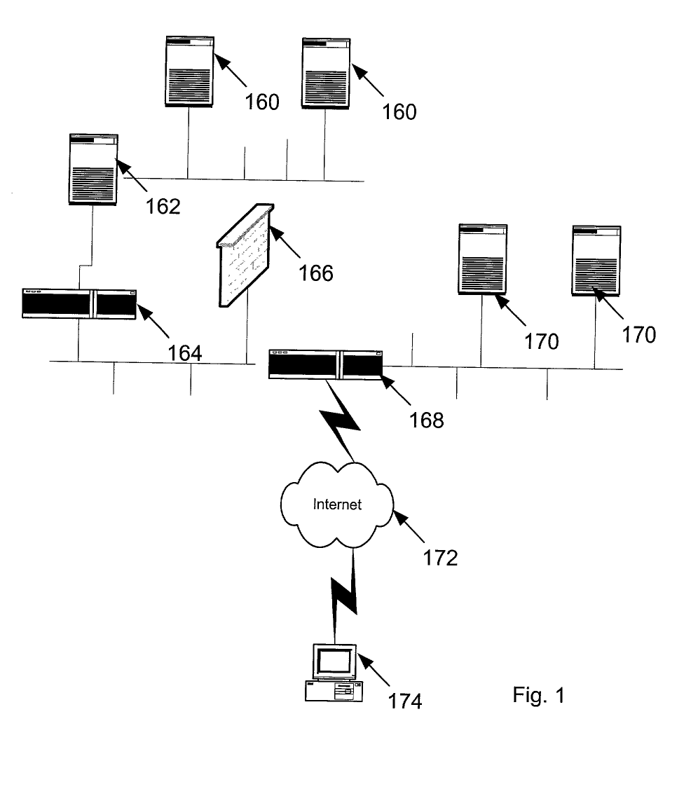

FIG. 1 depicts one embodiment of a system-to-internet connection architecture according to the present invention. A private web server 162 is connected to production servers 160. The private web server 162 is preferably connected to the Internet 172, most preferably via an outbound router 164, behind a firewall 166 and on a non-published port in order to prevent hacking into the system. The private server 162 houses the system and is available only to registered users. An inbound router 168 is designed to allow all traffic and all types of users get to the public site. The outbound router 164 restricts traffic coming into the system to only HTML requests for a certain Internet port address, protecting the private server 162 and the production server 160 from being hacked. Public web servers 170 store public information, such as web site page graphics, marketing information and a demonstration of the system for anyone surfing the Web, such as using browser 174.

Preferably, the server consists of an integrated set of software modules and network servers designed to process all closings efficiently and securely. Functionality is separated both logically and physically in order to achieve greater scalability. The server is preferably constructed preferably using true Object Oriented Design (OOD) and Development techniques and preferably employs an XML/ JAVA/UNIX solution in keeping with the current standards of the industry for developing state-of-the-art Internet solutions. The server, however, may be modified so as to conform to any platform.

Typically, a computer 174 is preferably a Windows PC with attached peripherals, such as an external digital video camera, a laser printer, a signature pad and biometric data gathering equipment, such as a fingerprint scanner, digital camera or a digital voice recorder. For example, the external fingerprint scanner, digital camera or digital video camera can be required for identity verification of all users and participants. The system will be accessed preferably via a standard Internet connection and use of a web browser, such as Netscape Navigator or Microsoft Internet Explorer, and security is ensured additionally through the use of passwords, user identification numbers and personal identification numbers, as well as biometric data.

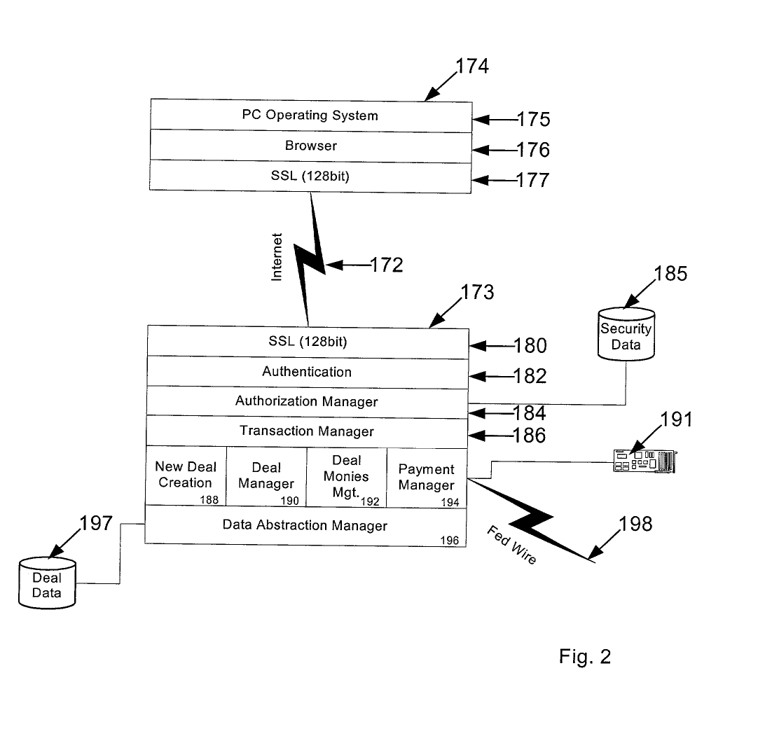

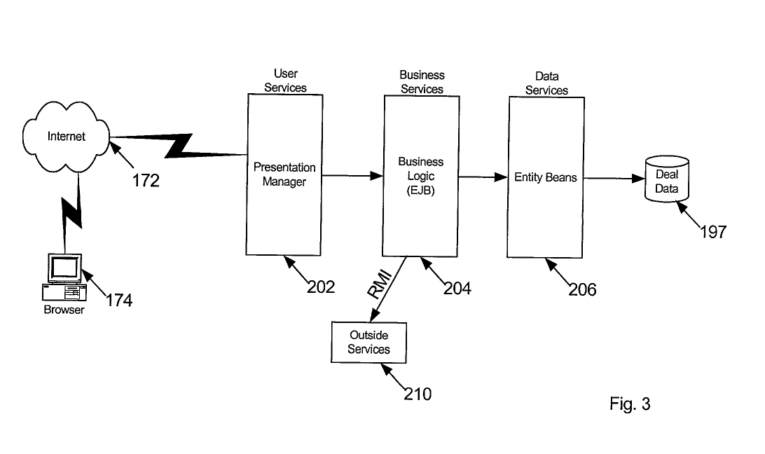

Computer 174 has virtual programming layers for an operating system 175, a browser 176 and an SSL 177, as shown in FIG. 2. Computer 174 will be used and configured to capture images, signatures and biometric data, such as digital fingerprints, of all transaction participants, connect to a central server 173 for processing of transactions, and print all transaction closing reports. In the illustrated examples, computer 174 communicates with server 173 via Internet 172, but may use any form of electronic communication. In one preferred embodiment of the system, server 173 consists of an integrated set of several software modules, each of which is responsible for some part of the overall function. In general, the system operates under software control, and the system architecture is not crucial to the operation of the system, as long as the functions and methods are carried out. However, FIGS. 2 and 3 show alternatives of the logical software architecture, using integrated OOD, and the connection between a computer 174 having web-access and a central server 173.

FIG. 2 shows one embodiment of the logical software architecture of server 173. In this first embodiment, the Authentication Module 182 is responsible for storing and comparing all user station private keys, and identifying server 173 to the requesting station 174. Once a connection between a user's computer 174 and server 173 has been established, a participant may log into the system. All users of the system are issued some verifiable and secure means of identification, such as a password, a user identification number (user ID) and/or a personal identification number (PIN). Preferably, the password allows access by the user into the secure electronic interface that has been specifically set up for that transaction, the user ID identifies the user or participant to the transaction who is requesting access to the system, and the PIN is used by the user generally only when authorizing a transaction, such as a transfer of funds or the like.

In the first embodiment of the software architecture, Authorization Module 184 is at this point responsible for validating both the ID and password of the participant, accessing the appropriate transaction, and enforcing the restrictions of the transaction based upon the information stored in the security database 185 relating to the participant. Entering a password and transaction or user ID will allow a user access to all transactions for which Deal Creator 188 has authorized access as a participant, but preferably only for those actions or areas of the system for which the participant has been authorized, such as viewing or updating. Each user will preferably be required to change his password upon initial entry into the system, and the new password will be stored in encrypted form on the server. Authorization Module 184 is also responsible for processing all password changes and informing users when their password has either not been changed or is about to expire.

Each participant for each transaction whose signature is necessary to complete the transaction may have a digital certificate in order to validate and digitally sign transactions. For most real estate transactions, each title agent, as the primary “deal manager”, or title company representative using this system is assigned a unique digital certificate. An authorized digital certificate vendor, such as, either IGN or CyberTrust, will issue these certificates, preferably a X.509 digital certificate, with the system acting as the Certificate Authority verifying the information provided by the individual or company prior to certificate issuance. This process will ensure that all transactions can be signed using a valid digital certificate.

Once a login has been validated, Authorization Module 184 then loads the transaction and passes control to the Transaction Manager module 186. Transaction Manager 186 is responsible for identifying the state of the transaction and the actions available to the user. Based upon these parameters, Transaction Manager 186 will present the appropriate transaction interface to the user and capture the user's desired action. Transaction Manager 186 will then pass the customer information to the Deal Creator module 188, Deal Manager module 190, or the Payment Manager module 194, depending on the stage of the transaction at the time.

When a new transaction is scheduled, a new secure electronic interface is preferably set up for that transaction. Deal Creator 188 accepts and enters information on all participants, i.e., all involved parties, and on the transaction into a database. The result of a deal creation is the establishment of a transaction record, a new set of customer records, the generation of a transaction or deal ID number, as well as a secure electronic interface specific to that transaction. In addition, as discussed above, anyone involved in the specified deal who is new to the system is assigned some verifiable and secure means of identification, such as a password, a user ID and/or a PIN. Creation of a deal also triggers letters or e-mails to all participants confirming their IDs, Passwords and/or PINs.

When an existing transaction is accessed, Deal Manager 190 is preferably responsible for managing that transaction. Deal Manager 190 will process all additions, changes or deletions to the transaction information, including updates of participant information such as passwords and secure banking information. Deal Manager 190 will also calculate and update all calculations, such as those regarding payoffs, disbursements and taxes. Furthermore, Deal Manager 190 is responsible for ensuring that all transaction participants have registered security information, preferably biometric data, such as a photo image, voiceprint or fingerprint, with the system and that all necessary reports are printed on the user's station printer. If the required digital images, voiceprints or fingerprints cannot be obtained, Deal Manager 190 can override the requirement.

The system preferably also includes an electronic payment initiator 198 as a secure and final payment or funds transfer system, such as Fed Wire or ACH, in order to instantaneously process any amounts due. In addition, the system can also allow credit card payments. Because accounts are opened and tracked electronically, the system streamlines the entire process of paper-based finds transfer, reduces the chances of fraud, and allows for a fast and check-free process with easy bookkeeping.

When closing participants authorize the transfer of finds, Payment Manager 194 creates the electronic payment requests and processes all electronic payment acknowledgements, which could be made by any secure and final payment system via electronic payment initiator 198. Cryptographic co-processor 191 ensures that all payment information and data is encrypted, so that theft of payment information is deterred. Payment Manager 194 gathers the banking information stored by Deal Manager 190 and validates all fund transfer based requests. If a transfer fails, Payment Manager 194 can lock the transaction and require additional information or require the creation of a new transaction in order to proceed. The system preferably uses standard cash management software as the interface with any clearing bank.

In order to allow for robust transaction processing and high scalability, all data access functions are preferably removed from the other modules and placed under the control of Data Abstraction Manager module 196, which is preferably the only module with access to information on transactions stored in Deal Database 197. In one embodiment, other modules have no ability to access deal data or where it resides; instead, they merely issue a request to Data Abstraction Manager 196 for specific information, and Data Abstraction Manager 196 will fulfill the request and return the appropriate data. This is type of system known as data abstraction and is a well-known fundamental component of true Object Oriented Design.

FIG. 3 shows another, more preferred embodiment of the logical software architecture of server 173. lin this second embodiment, system server 173 consists preferably of only three integrated software modules, replacing all the modules of FIG. 2. In the embodiment of FIG. 3, server 173 has a User Services module 202, a Business Services module 204 and a Data Services module 206. Of course, computer 174 can be configured as discussed above and have an operating system 175, a browser 176 and an SSL 177, and will be used and configured to capture images, signatures and biometric data, e.g., fingerprints, of all closing participants, connect to server 173 for processing of transactions, and will print all transaction reports.

User Services module 202 contains all the services and programming necessary to present the system interactively to the user, i.e., to interface with the user and manage the process accessed by the user. For example, User Services 202 contains a multitude of variable web interface pages, preferably formatted in the Java language, for presentation to the user's browser 174 when requested by the user. The system preferably has approximately twenty basic server pages, each of which displays different data depending on the web button accessed by the user. Each server page has a presentation manager that is responsible for formatting and managing that page from server 173 and for sending to the page any data that is to be displayed. Each presentation manager knows the server page formatting and how to supply it to the browser. Each presentation manager also configures all system output and information to the user, accepts for processing all user input and formats, and processes information from the user.

Business Services module 204 contains all specific business logic for the system and controls the great majority of business-related functions, with assistance from the Data Services module 206, Database 208 and outside services 210. Generally, the individual business related acts are performed by discrete software “entity beans” in Data Services 206 and coordinated by Business Services 202, such that, whenever Business Services 202 requires certain businessrelated functions, it directs either Data Services 206 or an outside service 210 to perform this function. Preferably, all data access functions are preferably removed from the other modules and placed under the control of Data Services 206, which is preferably the only module with access to information stored in Database 208. The other modules have no access to Database 208 where transaction data resides and have no ability to access it; instead, they merely issue a request to Data Services 206 for specific function, action or information, and the appropriate entity bean in Data Services 206 will fulfill the request and return the appropriate data. If the function is to be performed internally, one of the entity beans Data Services 206 performs the function and, with access to information stored in Database 208, returns the result to Business Services 202. If the function is to be performed externally, a request is made for a remote method invocation (RMI) and the outside service 210 performs this desired function and returns the result to Business Services 202.

For example, once User Services 202 accepts an ID and password that have been entered by a participant, Business Services 202 will arrange for validation of the ID and password, by directing an appropriate entity bean within Data Services 206 that is specifically for this function. The specific entity bean within Data Services 206 accesses Database 208 as needed for retrieval of participant ID and password information. Another entity bean accesses the appropriate deal from database 208 and enforces the restrictions of that deal based upon the information stored in database 208 relating to the participant and the deal. If access is permitted, Business Services 202 will allow the authorized deals and will direct User Services 202 to make screen presentations to the user as appropriate.

User Services 202 will present the appropriate transaction screen within the specific electronic interface to the user and capture the user's desired action. User Services 202 will then pass the customer information to Business Services 202 for coordination of the user's action. Based upon the information entered or the action desired, Business Services 202 will access the appropriate entity bean in Data Services 206 to process information, such as acceptance and entry of information on all participants and on the transaction, into database 208. Database 208 establishes a transaction record, a new set of customer records and a transaction or deal ID number. If an existing transaction is accessed, User Services 202 will accept all changes to the transaction information, including updates of participant information such as passwords and secure banking information, and will pass this information to Business Services 202 for coordination of entry into database 208 by the proper Data Services 206 entity bean. Business Services 202 will also direct the proper Data Services 206 entity bean to perform and update all calculations, such as those regarding payoffs, disbursements and taxes.

Outside Services 210 are accessed by Business Services 204 through remote method invocation whenever tasks are required by entities outside the system. Examples of third party outside services 210 are an electronic payment initiator that coordinates electronic funds transfers, such as Fed Wire or ACH, or credit card payments, a credit checking and identity verification service, such as Equifax, Experian or Trans Union credit bureaus, that ensures that information provided by a user is accurate and verifies the user's identity, and an electronic security company that generates digital certificates and verifies those digital certificates that are presented to the system.

When a transfer of funds is authorized by transaction participants, Business Services 204 creates an electronic payment request, instructs the appropriate outside service 210 to perform the transaction, and processes all electronic payment acknowledgements. Business Services 204 accesses an appropriate entity bean from Data Services 206 to gather the banking information stored by database 208 and another entity bean to ensure that all payment information and data is encrypted.

The process of the system of the current invention will be described below as it applies to the specific embodiment of a real estate transaction. It should be noted, however, that the present invention can also apply to any contract-based transaction, and is most preferably used for those involving transfer of ownership of a high-value item.

When a transaction is initiated (i.e., before the closing), the participants are first required to enter all of the transaction, banking and participant information into the system. This is done preferably via a secure Web Site. Generally, all sources of funds and payments will also have to be identified, and documents will have to be created or posted for review by the other parties. A private transaction “space,” or personalized electronic graphical user interface or site, is initialized and created on the system's Web Site and is unique to the transaction (or property) to create or hold all transaction information and to present information about the transaction in a condensed, organized manner in one place. Through a transaction identification number and passwords, the transaction space is accessible only by participants who are registered for the particular transaction and allows those with authorization to input and edit information about the transaction and the participants. Certain participants may only have authorization for certain tasks, and those participants will be limited in the actions they may take to the restricted actions.

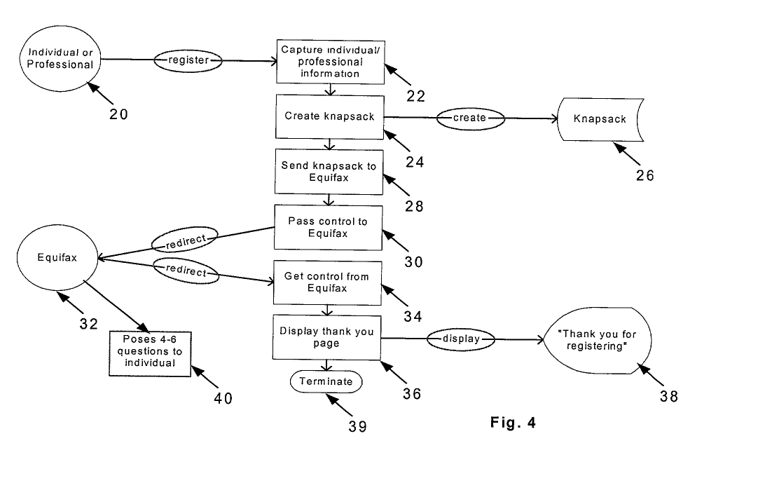

FIG. 4 shows a flow chart for the participant registration process. A participant to a transaction may be, for example, one or more of the following: a buyer or seller, a borrower (e.g., in a refinance), a title closer, an attorney (e.g., for one of the participants), a broker (e.g., mortgage broker or real estate broker for a buyer or seller), a payoff entity (e.g., a bank or title agent), a settlement agent, a lending institution or any other individual or professional who has been assigned or permitted access to the transaction process.

A user, who may be an individual, real estate professional or any other participant, logs onto the system (step 20). The user may be at a specially configured station 174 or at the user's own web-enabled device. The user is taken into the registration process, where the system captures registration information (step 22), which is general information about the registrant. Preferably, the registration information includes the registrant's name, address, social security number, driver's license number, and contact information (telephone number, fax number and e-mail address). Preferably, the registration information should also include the registrant's role in the closing and certain role-specific information. For example, a registrant with a professional role enters a professional ID number, such as an attorney's state bar number or a real estate agent's license number. If the registrant is an individual, that individual's bank information or credit card information is required.

A third party identity verification service, preferably one with access to an extensive credit history database, the Department of Motor Vehicles database for each state and telephone records for each state, is used to verify identity of the registrant. One example, illustrated in FIGS. 1 and 2, uses Equifax as the third party identity verification service, although other third party identity verification services, such as Experian or Trans Union credit bureaus, may also be used with similar effect.

The registration information is preferably used to create a “knapsack” (step 24), which is a specific file format for Equifax. If another third party identity verification service, such as Experian or Trans Union, is used, then the specific file format of that third party identity verification service may be used for convenience. Using the specific file format of Equifax, the system sends the knapsack 26 to Equifax (step 28) with the registrant's name, social security number, address, previous address, driver's license information, and e-mail address. Once the knapsack 26 is sent to Equifax 32, control of identity verification is then passed (step 30) directly to Equifax 32 for credit-related questioning of the user 20 (step 40) for identity verification.

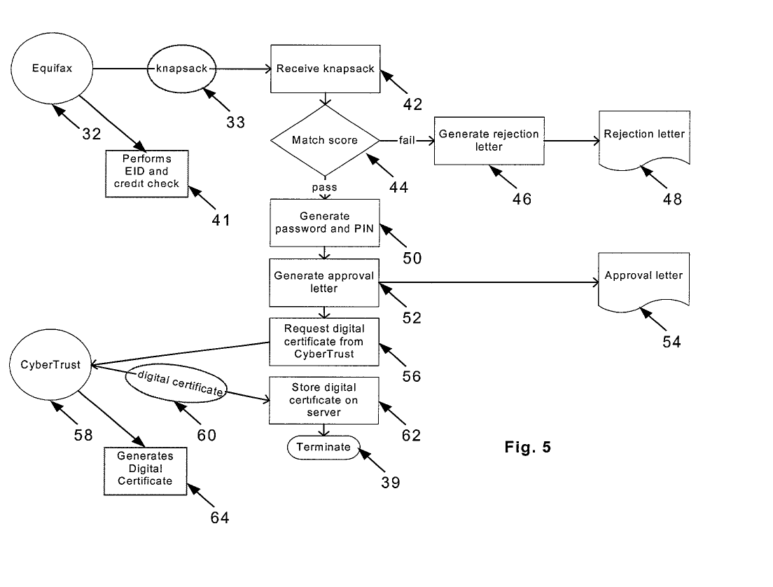

As shown in FIG. 5, Equifax 32 also generates an Electronic Identification (EID) and credit check (step 41). Equifax creates another knapsack (step 33) with scores from various credit tests run by Equifax and a final evaluation of identity verification of the person registering. One preferred means of scoring is by using a probability rating of Low, Medium, High, and Very High. Equifax then passes the knapsack 33 and control back to the system (step 34, FIG. 3) for approval of the user. The total Equifax identity verification score must be above a predetermined threshold in order for the user to be approved by the system.

Once the system receives the knapsack 33 from Equifax (step 42), the system matches the score provided by Equifax with the pre-determined threshold. Preferably, using the scoring means described above, registrants who score Medium or higher are accepted by the system, while those registrants that receive a Low rating are not accepted and are asked to contact Equifax for further information. If the score fails to meet or exceed the pre-determined threshold, a rejection letter 48 is generated (step 46) and sent to the user. If the score does meet or exceed the threshold, a password and PIN is generated (step 50) and an approval letter (or e-mail or other secure communication) is generated (step 52) and sent to the user (step 54). The approval letter preferably includes the user's ID, password, PIN and contact information for the system in order for the user to activate his account.

Next, a request is generated for a digital certificate (step 56) and is sent to a trusted third party electronic security company (step 58). This example, illustrated in FIG. 5, uses CyberTrust as the third party electronic security company, although other third party electronic security companies may also be used with similar effect. CyberTrust 58 generates the digital certificate (step 64) and sends the certificate to the system (arrow 60), and the certificate is stored on the system server (step 62). Preferably, the digital certificate used by the system is a standard X.509 certificate, which contains the individual's name, social security number, a unique certificate number (as described by the National Institute of Standards and Testing), and a root identifying its generation by a trusted third party electronic security company, such as CyberTrust. Continuing in FIG. 4, a thank-you page 38 is displayed (step 36) for the user and the system then terminates the process (step 39, FIGS. 4 and 5).

In an alternative embodiment, the entire third party identity verification process can be skipped for professionals because it could be safe to assume that professionals in good standing are qualified. A check with the licensing organization of the professional can be used instead.

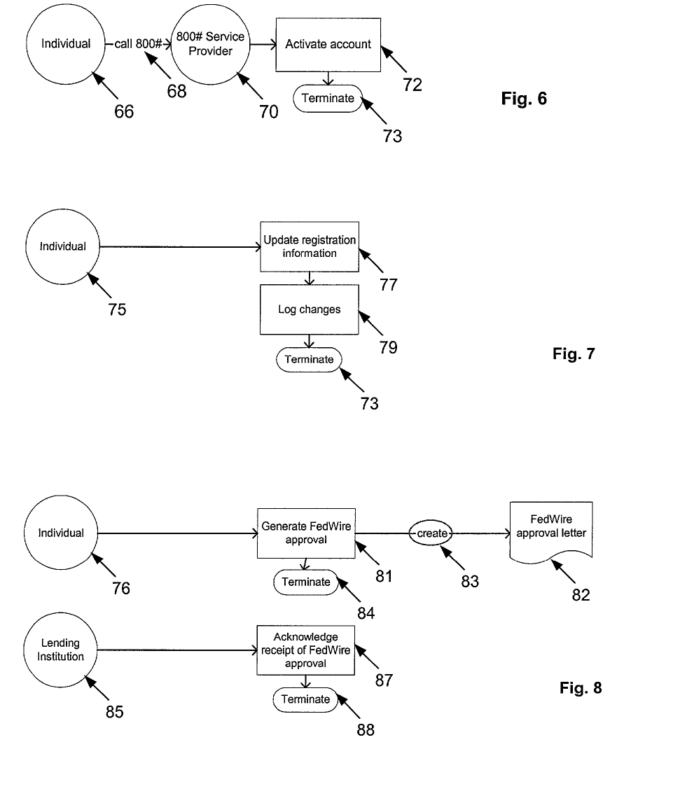

After registration has been completed, it is preferred for the registrant to contact the system, perhaps by calling a toll-free number, in order to activate his account, as outlined in FIG. 6. The individual 66 calls an 800 number (step 68), and the 800-service provider 70 activates the account (step 72). Once the account is activated, processing is terminated (step 73). Only active, registered professionals and individuals can participate in the transaction space.

After all registration information is recorded, users may make changes to passwords, addresses, e-mail or other personal information, and the process is outlined in FIG. 7. Participants can also verify their registration information and enter account information for funds transfers to occur during the closing. An individual user first logs on (step 75). When the user chooses to update his registration information, the information is displayed and the user has a chance to make any necessary changes or additions (step 77), such as to the name, address, telephone or fax number, e-mail address or bank information. The change will preferably require entry of the old value and the new value for security purposes. After changes to the registration information are made, all changes are logged (step 79) in a file for audit purposes, and the process terminates (step 80).

Each participant to the transaction is assigned an initial password for each transaction. The first time any party logs onto the site, the password must be changed to ensure that no one, not even the sponsoring company, has that party's same password. The party preferably also “executes” a click-thru agreement limiting the sponsoring company's liability for the transaction. In order to prevent the possibility of a forgotten password stopping a transaction, certain unique information is also entered in order to substitute for the password in the event that the password is forgotten. For example, each user will be asked to provide both a question and an answer to that question that only that user would know, such that, if a user forgets his password, the user will be presented with the user-specific question and, if the question is answered correctly, the user will be allowed into the system. The user's password preferably will never be displayed, nor will it be accessible in plain text form by anyone.

A bank-approved electronic funds transfer authorization can also be issued by the system, and this process is outlined in FIG. 8. Any electronic funds transfer authorization may be used, such as one run by the Federal Reserve, known commonly as FedWire approval, as well as other commercial electronic finds transfer options, such as ACH. Generally, after a participant logs on to the system and selects a transaction, he selects an option to generate or issue an electronic funds transfer approval (step 76). The system generates the approval (step 81), which can be displayed to the user via the system, creates a printed letter (step 83) and terminates (step 84). The system also sends the approval letter to the lending institution (step 85), which, in turn, acknowledges receipt (step 87). The participant signs the authorization form, digitally (and authenticated) if the authorization is in electronic form or by hand if the authorization is in paper form, and sends the signed authorization to the lending institution, which updates a flag on the system, acknowledging receipt of the approval. The system then terminates processing (step 88).

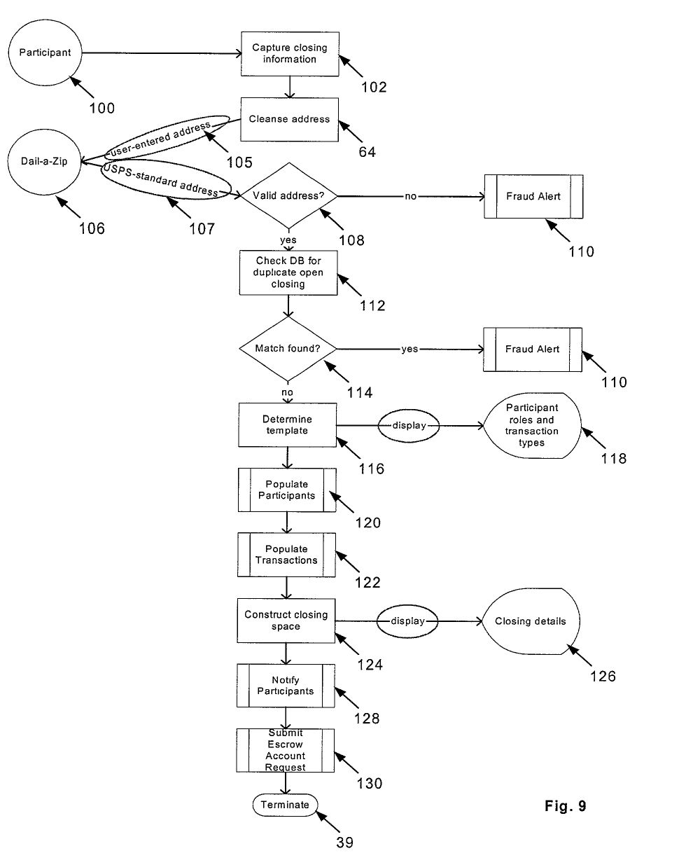

FIG. 9 shows the steps for creating a new transaction. A participant in the transaction logs onto the system and chooses to create a new transaction (step 100). The participant could be a buyer, seller, a borrower, a title company, title agent, payoff bank, other payoff entity, lending bank, title closer, sales or purchase broker, buyer's attorney, seller's attorney, bank attorney, mortgage broker or any other individual or professional who has been assigned or permitted access to the transaction process, but is preferably either an attorney or a broker. The participant enters basic transaction information (step 102) such as property address, type of property, type of transaction (e.g., sale, refinance, subordination or modification) and perhaps even the transaction amount. The property address is preferably standardized or “cleansed” (step 104), which means that the address is converted to a United States Postal Service (USPS) approved version (e.g., 40 River Road is “cleansed” to 40 RIVER RD). In addition, all Zip Codes are changed to ZIP+4+2. The user-entered address 105 is sent to an address validation service, such as Dial-a-Zip 106. The address validation service matches the user-entered address against a USPS version and, if one exists, the address validation service returns a USPS-standard address 107. The system checks the returned address for validity (step 108) and, if the address is not valid, a fraud alert is issued (step 110).

If the address is valid, the system database is then checked for a duplicate open transaction (step 112). The system uses the information already entered by the participant and queries whether a match is found (step 114). The system issues a fraud alert if the transaction has already been entered and is still open (step 110). If a match is not found, the system creates a template (step 116) that requires entry of the list of participants, transaction types and document types needed for the transaction. The participant roles and the transaction types are displayed to the user (step 118) in order to provide the user with populating options when completing the template. The participants themselves can enter the types of documents required or, as will be discussed below, the system determines the specific documents required, and even prepares them, based upon the transaction information entered by the participants in view of stored information regarding the documents required by various jurisdictions or localities and by the various lending institutions and banks.

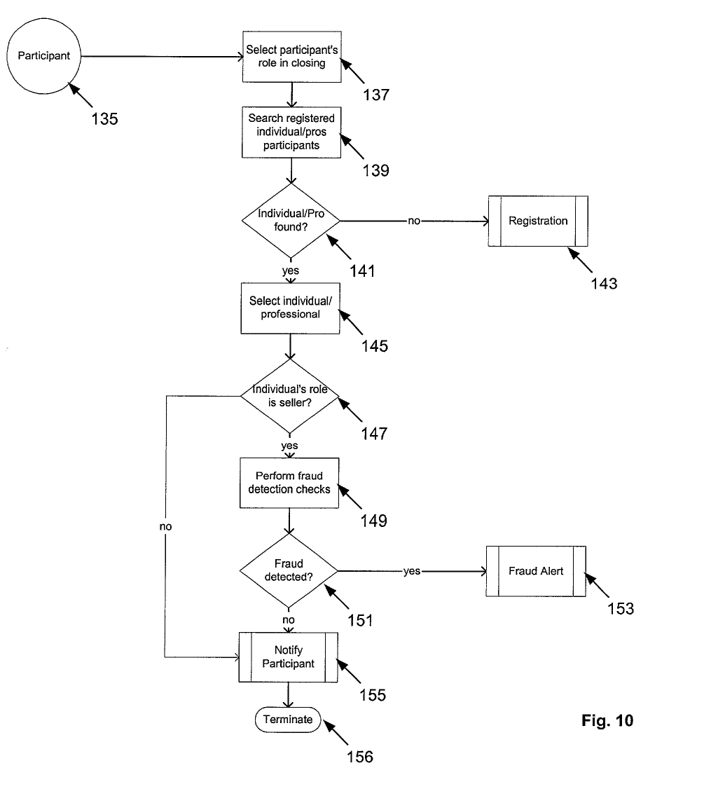

Each user must populate himself as a participant in the transaction (step 120), preferably through a process such as outlined in FIG. 10. The participant 135 logs into the system and selects the option to populate participants in the transaction. Participant 135 selects its role in the transaction (step 137) and the system searches the individuals and professionals that are registered for the particular transaction (step 139). This searching could be done using information already entered, such as by name, social security number or address. If the user is not already in the system (step 141), e.g., in another transaction, he will be brought to the registration process (step 143) of FIG. 4. If there are registered individuals or professionals for the role, one is selected (step 145) from a drop-down menu in the applicable participant section. The system queries whether the individual's role is that of seller (step 147). If not, the participant is notified (step 155), preferably via e-mail, that he has been invited to participate in a transaction closing. If the role being filled is that of a seller, a security check is performed (step 149). If fraud is detected (step 151), an alert is issued (step 153). If no fraud is detected, the participant is notified and the process terminates (step 156).

If the user has more participants to enter, the above process is repeated until all participants are entered. Alternatively, the system may be set such that only a participant may populate himself into a transaction, and the process is repeated by the participants themselves until all participants are entered.

In a preferred embodiment of the invention, once a user registers or is populated into the transaction as a participant with a defined role in the transaction, the system assigns a “privilege level” to that participant in accordance with that participant's transaction role. The system assigned privilege level is, in effect, a security clearance that defines what actions the participant may take relative to the electronic graphical user interface. In one embodiment of the privilege levels, the following could be examples of some of the levels of privilege, in ascending order, that could be assigned to the various participants based upon their roles:

the participant may view only documents relating to him but may not edit those documents, and the participant may or may not have any information regarding documents relating to other participants;

the participant may view and edit only documents relating to him;

the participant may view a list of documents relating to other participants, or may view the properties of those documents, but may not edit those documents themselves;

the participant may edit, i.e., add to, delete from and/or modify, documents relating to him as well as to other participants;

the participant may manage the specific rules or requirements for documents or for the transaction relating to him that are stored in the database; and

the participant may have the ability to place or loosen privilege restrictions upon other participants.

The following are examples of the uses of privilege levels, such as those shown above. The system may assign to a participant whose role is that of a seller a privilege level that prevents him from viewing or editing certain documents of the buyer but allows him only to monitor the progress of those documents. A participant whose role is that of a witness may be assigned a privilege level that allows him to view only documents that he is to witness and not to edit any documents or their properties. A participant whose role is that of a lender may view documents but may not edit them or their properties. Certain participants may not view the properties of documents. Certain participants may be able to modify, e.g., relax, the rules or requirements that have been stored in the database as relating to that participant and the transaction and its documents. The levels of privilege assigned by the system are intended to allow the secure electronic space to be managed efficiently and consistently with the levels of responsibility and authority of the respective participants.

Next, referring back to FIG. 9, specific information regarding the transaction must also be entered (“populate the transaction”) (step 122). For a real estate transaction, the information preferably includes the property type (such as condominium, planned unit development, single family dwelling, multiple family dwelling, business, mixed use, co-op, etc.) and address and the type of transaction, as well as participant information regarding the purchaser, the seller, the title agent, the attorneys and all other relevant available participants, information that may be entered by the participants themselves, as described. For the purchaser, the information preferably will also include information regarding the lender and information regarding the bank account from which the purchase price funds are to be transferred. For the seller, the information preferably will also include the persons and account numbers for the locations to which the purchase price funds are to be sent, and the amounts to be sent to each party. Parties such as real estate agents and pay-off banks, either directly or indirectly through the seller, input their bank account number and any other necessary funds transfer information for receipt of funds.

After the transaction has been populated (step 122) and at least some of the participants have been populated (step 120), the secure on-line transaction space or electronic graphical user interface is constructed on the system (step 124). The transaction space can be initialized by one of the participants or is preferably created automatically by the system once certain minimum information regarding the transaction has been input. The transaction space is constructed based upon the various information entered by the participants regarding themselves and regarding the transaction in order to make available to the participants all the transaction details (step 126). The transaction space is, therefore, specific to the particular transaction and to its participants, and is preferably accessible by the participants only by password or some other security means. Participants are notified (step 128) of a transaction identification number (ID) for access to the secure transaction site, and a request for an escrow account is submitted to a bank (step 130).

In connection with the creation of the secure electronic transaction space, it should be noted that the system is preferably a rules-based system. As such, the system stores information regarding the many different laws, rules or requirements, including custom or habit, regarding the many different types of information that may be required by the many different entities or participants that may be involved in the transaction in some way, with regard to the transaction, property, funds transfers, payments, document format and content. These rules can be the laws of all the possible individual localities and jurisdictions as well as the regulations or requirements of all the possible participants, professionals and authorities that are authorized to participate in such transactions, such as lending and financial institutions. These rules could also include the requirements of such jurisdictions and participants, including professionals and authorities in such jurisdictions, based upon the observed habits and customs of each, many of which may not even be recorded elsewhere. The precise selection and articulation of the various rules and requirements preferably reflect the experience, judgment and creativity of the system.

In order to prepare the secure transaction graphical user interface, each rule must be compared with the others, according to the rules of each type of information. There may be document rules, location rules, participant rules, privilege rules, financial transaction rules and closing transaction rules, as well as other types of rules, each of which may be completely independent of all the other rules but each of which impacts in some way upon whether certain information, participants, documents, types or forms of documents, or payments are required for a particular transaction. The final set of required information, participants, documents, types or forms of documents, and payments, with which the secure electronic transaction space is created, depends upon the aggregation and correlation of the sum of input data relating to the specific location, participants and transaction involved.

Therefore, the output of the system, i.e., the secure electronic transaction space, will generally, in many respects, such as required forms or participants, templates for entry of additional information, or the content and format of the secure transaction space, depend upon the integration of various rules, requirements and customs that are stored in the system memory, which integration can be a concatenation, a union or an intersection of variable information. The system will analyze the variables and determine the appropriate points of intersection and integration. The system will then determine the information, participants, documents or forms that are required, in view of all the information that has been previously input regarding the transaction and its participants. Accordingly, each of the transaction-specific electronic interface, the templates for entry of information regarding the participants, property and payments, and the forms and documents needed for closing of the transaction may change dynamically depending upon previous entries of information and upon changes thereto. In other words, changes to previous entries of information may change the requirements for additional information needed in order to conclude the transaction.

One illustration of the rules system is a location rule, which preferably resolves all possible localities for a given zip code, up to the state level, by determining requirements for transactions, participants and documents at each locality level. The location of the property impacts upon the identities of the participants, documents, payments or financing that are required. For example, for certain types of transactions or when the transaction concerns a particular type of property in a given location, the governments in certain localities and jurisdictions may require that certain types of documents or specific forms of documents be used, that certain types of participants be included in the transaction, or that certain payments be made. Thus, once the information regarding the property and location is input, including the location and type of the property and the type of transaction, the rules implicated by these entries may mandate that specific documents or specific forms or templates of documents, be included in the document set in order for the transaction to be complete. These rules may also require that certain types of participants be invited to participate in the transaction or that certain payments be made in order for the transaction to be complete.

Another example of the rules system is a transaction rule, which could be financial transaction rules, closing transaction rules, etc., and is a rule that applies specifically to the type of transaction being conducted. Naturally, there are many different types of transactions that may be handled by the system, and each transaction requires different types of documents as well as different types of participants. For example, a purchase transaction without financing requires different documents and participants than does a purchase transaction with financing or does a refinance transaction. In addition, such transactions with a second mortgage require different documents and participants than do such transactions with a first mortgage.

Transaction rules can also be affected by the type of property being transacted, since a transaction for one type of property may have different rules and requirements than the same type of transaction for a different type of property. For example, in the real estate field, the types of properties being transacted can include business properties, industrial properties, single family dwellings, multiple family dwellings, condominiums, cooperatives, etc. There may be considered a separate category of transaction rules called property rules, which are requirements and rules that are determined by the type of property being transferred within the transaction. In general, however, property rules can be subsumed within the transaction rules, since the transaction can be said to include the type of property being transacted.

Another example of the rules system is a participant rule, which is a rule that applies specifically to an individually named participant or to any participant according to his role. In the first case, where the participant rule applies specifically to an individually named participant, the rule could be driven according to the individual participant, for instance, to require further considerations or features because of several reported instances of fraud concerning one specific individual or institution. In such a case, the system could require that additional safeguards or precautions be taken whenever that individual or institution is involved in a transaction as a participant, for example that additional certification be needed or that certain the presence of specific individuals be required. Alternatively, the rule could arise because of the specific requirements of the named participant, such as a requirement by a particular lending institution that attorneys for each party must be present, that a specific credit threshold must be met by the borrower of funds, or that additional documents are required. In the second case, where the participant rule applies to any participant according to the specified role, the rule could be one that is mandated by the system according to the role played by the participant, such as that all participants in the role of lending institution are required to be represented by an officer bearing a specific level of title or responsibility at the lending institution.

In addition, participant rules may also arise as a result of another rule, such as a location rule or a transaction rule. For instance, when a particular location is the site of a specific type of property transaction, the municipality in that location may mandate that all participants in the role of a lending institution be represented by an attorney or by some specified officer of the lender. In another example, when a particular type of property is being transferred in a particular type of transaction, e.g., a cooperative dwelling is being purchased with a mortgage, certain types of participants, e.g., lending institution loan officer or cooperative board member, may be necessary to complete the transaction, whereas those participants may not be necessary for other types of transactions or transactions involving other types of property, e.g., single family dwelling being purchased without a mortgage.

A further example of the rules system is a document rule, which generally determines the types and numbers of documents that are required for the transaction, the forms of those documents and how those documents are handled. However, because most documents are generally required by law or by participant requirement and custom, document rules are generally driven by other rules, such as location rules, participant rules or transaction rules, whereby certain transactions may require that specific types of documents be used, or certain jurisdictions or participants may have their own requirements or customs regarding the documents to be used, the form and content of those documents and how those documents are to be handled, depending upon the transaction involved A still further example of the rules system is a privilege rule, which determines what actions each participant may take relative to the system. As described previously, the system assigns each participant a privilege level for each individual; transaction that determines how the participants may act and interact with respect to the secure transaction interface, and these rules are generally also dependent upon other rules, such as location rules, transaction rules, participant rules and document rules. Furthermore, the system may allow a participant to have one level of privilege for one use and a different level of privilege for another use.

Some of the rules or requirements incorporated into the invention may be no more than written or unwritten customs or habits of professionals, authorities or other participants that, while not strictly required for the transaction by law, will yield desirable results in many circumstances. For example, certain professionals or authorities may, by regulation, by habit or by custom, have certain documents or particular forms or templates of documents that they require or prefer to be used for various reasons when conducting certain types of transactions, and these requirements must also be considered. These requirements, habits or customs may be different depending on the jurisdiction, locality or even neighborhood. For example, the requirements, habits or customs of professionals and authorities in one neighborhood or locality may be different from the requirements, habits or customs of other professionals and authorities, or even of those same professionals and authorities, in another jurisdiction, locality or neighborhood, even within the same jurisdiction.

In addition, the written or unwritten requirements, habits or customs of professionals, authorities or other participants could also depend upon the market niche being served by the transaction. For example, professionals and authorities may have a different set of requirements, habits or customs in the market of luxury single-family homes than they do in the market niche of middle priced single-family homes. Of course, the requirements, habits or customs could relate to, i.e., affect or be dependent upon, the location, the type of transaction, the documents, the participants, etc. Furthermore, certain jurisdictions or localities may have their own specific requirements or rules regarding the privileges or restrictions of certain participants, such as those that mandate that certain participants be restricted from handling certain tasks. Thus, these requirements impact upon the system's privilege rules as much as any other rule outlined above.

One example of a requirement that is a custom or habit of professionals, authorities or other participants is a document or action that is known by those participants in the relevant field in the relevant jurisdiction to expedite matters. For example, an experienced loan officer may know that in a specific county a mortgage document will be processed more promptly with the county land records office—and thus limit the lender's exposure to prior liens—if the document is preceded with a cover letter that reads something to the effect of “County Clerk Smith: Priority action is kindly requested.” By habit, an experienced loan officer would include this type of cover letter with the mortgage document in the relevant jurisdiction. The rules and requirements in the system database might include this habit as an accommodation to the lender under some conditions, and might not under other conditions. Of course, such a requirement may be effective in one jurisdiction, locality or neighborhood but not in another jurisdiction, locality or neighborhood, or may be effective with respect to one market niche but not with respect to another market niche.

The concatenation or intersection of rules or requirements occurs when one rule or requirement is layered onto others. For example, participant rules may be layered on location rules. Although the location of a property generally has no relationship to the institution lending funds for a mortgage, when determining the documents necessary for a particular transaction, the documents that are required by a particular lending institution for the particular type of transaction in the particular location must be considered.

In another example of the concatenation or intersection of rules or requirements, the property location, property type and loan type all have an impact upon the number, type and format of the documents that are needed in order to complete the transaction, upon the number, types, identities and roles of participants that are required to participate in the transaction and upon the amounts and timing of payments that are required in order to close the transaction. The property type and loan type will each determine what documents are required from a named lending institution or jurisdiction, and certain participants, institutions or jurisdictions may require that these documents be in specific types and formats. Also, certain institutions or jurisdictions may require that there be particular attorneys or representatives for specific parties present, even when their presence might not otherwise be required by other institutions or jurisdictions, or that certain participants be restricted from performing certain tasks, even when those activities may not otherwise be restricted by other institutions or jurisdictions. Accordingly, other participant and document rules must also be considered, as one particular named jurisdiction, institution or participant might not require a particular document, yet another institution may require it. Similarly, privilege rules must also be considered, as there may be restrictions on the activities or privileges of certain participants that are required by certain jurisdictions, institutions or other participants. Thus, all the specific requirements of the various parties and participants must also be accounted for in determining the final requirements for the transaction space.

In a preferred embodiment, the system will be able to learn new rules, requirements and customs by analyzing historical transactions and comparing variables. Based upon past transactions, the system will “learn” the requirements, rules, documents, forms, habits and customs of jurisdictions and localities, participants, and professionals and authorities in those jurisdictions, even those that were not previously known or stored in the system database. As this information is acquired into the system, the system will formulate new rules or requirements based upon this new information. Then, in future transactions involving these parties, properties or jurisdictions, the new rules or requirements will be considered and taken into account when the system develops the secure transaction space and the document set for that transaction.

Any information that has been input into the system regarding the type of property, type of ownership, specific lending institution, etc. of that particular transaction will impact upon the financial, personnel or document requirements in some way, and the rules as stored in the system database sort out the requirements such that, once the information is input, the system considers all the rules before preparing the secure electronic graphical user interface and listing or posting thereon the participants, payments, documents and templates that are required for that transaction. Similarly, as discussed below, because there may be conflicts between the various financial, personnel or document rules and requirements, the system also maintains rules that govern the relationships between rules and requirements, i.e., to determine the primacy of certain rules over other rules in instances of conflict between them.

In addition, because some information may not yet be known to the participants at the time that the transaction is opened, the system updates the secure electronic transaction graphical user interface, as well as the participants, payments, documents and templates that are required for that transaction, according to the rules, as the information is updated. Thus, the system prepares the terms of the transaction and the secure electronic transaction graphical user interface based upon the information available to it at the time, and changes are made as updates or additions to the information is input. The system also supports tables or entries with “null” values, since a business logic does not need to supply values for all variables but rather just for those that it has at the time of the request.

With regard to documents that are listed by the system as being required for the particular transaction, any participant, such as a lender, may attach digital images of closing documents onto the secure transaction space for the purchaser/borrower and other participants to review. This can be done by uploading or scanning the documents, once they have been prepared by an external source. Alternatively, as discussed in greater detail below, the system can create the specific documents that are required for the transaction based upon a correlation of the transaction information as entered by the participants and the information stored in the database regarding the documents and information required by various jurisdictions or localities, by the various professionals and authorities that are authorized to participate in the transaction and by the various lending and financial institutions. These documents are created specifically for the individual transaction from templates for documents that are prepared by the system based upon information and data that is stored in the system database.

In one embodiment of the system wherein documents are created, the system preferably has a memory that stores information regarding the various laws and requirements relating to the participants, transaction, property, founds transfers, payments, document format and content, i.e., the “rules”, of all the possible individual localities and jurisdictions as well as of all the possible participants, professionals and authorities that are authorized to participate in such transactions, lending and financial institutions, and other participants. This database also includes the requirements of such localities and participants based upon the habits and customs of each. For example, for each type of transaction, the database stores information regarding the documents and participants that are necessary to each jurisdiction and locality, the documents (as well as their customarily preferred format and content) that are required by each participant and institution, the party that is customarily responsible for submitting such documents, what particular representatives or other participants are required to be present, what roles are to be performed by each participant, the funds that are to be transferred, the party that is customarily responsible for making such transfers, as well as a host of other such information not listed here.

In this first embodiment, the system preferably maintains a database for each variable, within which is an entry for every possible value of that variable. For example, the location variable has variable listings by zip code grouping and works all the way up to a listing of each value for each variable within that zip code. Thus, the system preferably stores the participant and document requirements for each transaction type, for each type of property, for each locality or jurisdiction, for each loan type, and for each participant and lending institution, etc., and has an entry for each possible variable. The system preferably also maintains a database for relations between variables, such as an order of preference to resolve potential conflicts between values. These relations between variables may also be known as “rules of rules”, since they are rules that resolve potential conflicts between the various types of rules.

In this first embodiment, the secure electronic space for each transaction thus begins with a clean slate, and variable values are added to populate this slate and help determine the requirements and the parameters of the electronic interface, as information is input. Once the information regarding the particular transaction and its participants has been input into the system, the system will analyze the various requirements of each of the participants, each of the relevant jurisdictions or localities, etc., and will determine the appropriate points of intersection and integration of these requirements. Based upon these points of intersection and integration, the electronic graphical user interface is created. The system then determines which participants and information are necessary for the transaction and have not been entered. The system preferably then also determines which documents or forms are required to be completed for the transaction, based upon the information input. As discussed above, the system can then require the participants to provide these documents for posting thereon or the system can generate these documents based upon the integrated rules stored in the system database (i.e., document types, formats and content required by all the variables).

In another, more preferred embodiment, the system preferably has a memory or a rules database that stores a base or default set of information regarding the participants, transaction, property, funds transfers, documents and content, i.e., the base rules or “axes”. The base set of rules are the default settings for any transactions of a certain kind that are set up within the system, regardless of geography, participants and financial institutions and arrangements. The axes preferably include participant rules, financial rules and document rules.

In this embodiment of the system, the system also preferably stores a set of variable rules of all the possible variations to the base rules, such as the various requirements as to the participants, transaction, property, funds transfers, documents and content of individual localities and jurisdictions, as well as of all the possible individual lending institutions and other required participants, that differ from those set forth in the base set of rules. This database of variations to the axes preferably contains a table of situations or conditions, having different entries than the axes, wherein the axes, or base set of rules, do not completely apply, i.e., the system maintains an entry for every possible variation from the default. Thus, the system preferably stores the participant and document requirements for each transaction type, for each type of property, for each locality or jurisdiction, for each loan type and for each lending institution, etc., only where such requirements possibly vary from the axes.

In this second embodiment, the secure electronic space for each transaction thus begins with a full slate of default values of the requirements and the parameters of the electronic interface. Once some basic information regarding the transaction is input into the system, the system makes certain assumptions regarding the requirements, based upon the axes. Once more information regarding the particular transaction and its participants has been entered into the system, the system will consult the variation tables to determine the various requirements of each of the participants and each of the relevant jurisdictions or localities that differ from those within the axes, and the system will determine which portions of the axes need to be changed as a result of the variation requirements. Then, variable values are added to adjust or change the default values of the requirements and the parameters of the electronic graphical user interface as needed and further determine the requirements and the parameters of the electronic interface. Based upon these points of intersection and integration, the electronic graphical user interface is created. With the information of what is required for this particular transaction, the system then determines the participants and information necessary for the transaction that have not been entered. The system preferably then also determines which documents or forms are required to be completed for the transaction, based upon the information input. As discussed above, the system can then require the participants to provide these documents to the secure electronic transaction interface for posting thereon or the system can generate these documents based upon the integrated rules stored in the system database (i.e., document types, formats and content required by all the variables and the base set of rules as modified).

Thus, in this second embodiment, certain assumptions are made with respect to the documents and other information that is needed for any particular transaction, based upon the base set of rules, and the electronic interface or transaction space, as well as documents that are posted thereon, are created based upon those assumptions. In many cases, changes will be made to the default settings for particular transactions, as additional information is input into the transaction space.

In either of these two embodiments, there may of course be some instances and transactions wherein certain rules or exceptions to rules are considered new and, therefore, must be added to the database. Thus, in a most preferred embodiment, the system will be a learning system, such that it can generate new rules for future transactions by analyzing historical transactions and comparing variables. Then, based upon past transactions, the system will “learn” the requirements, rules, documents, forms, habits and customs of jurisdictions and localities, as well as participants, such as professionals and authorities in those jurisdictions, that were not previously known or stored in the database. Accordingly, in future transactions involving these parties, properties or jurisdictions, these new rules will be considered and taken into account when the system develops the secure transaction space for that transaction.

With regard to posting of the documents onto the secure electronic graphical user interface for the specific transaction, it is preferable that information be collected at the data level and that the system create the images of the required documents based upon the data input, rather than having participants upload the documents themselves for posting on the electronic graphical user interface for the transaction. Thus, in the first embodiment, data and information are first input, and the system then creates templates for documents that are necessary for the particular transaction, as determined based upon consideration of all the rules and requirements. Where certain information has not yet been entered and such information is necessary in order to create certain documents, for example, it is preferred that those documents not be created and the documents not be posted on the transaction space until that information is provided.

In the second embodiment, certain assumptions regarding the particular transaction are made first, and the transaction space is formed and document templates are created, even without all the necessary information. Then, as additional information is added, changes are made to the original assumptions as a result of the changed requirements to form a revised transaction space and to create document templates that are accurate for the particular transaction and circumstances. The result in either embodiment will be the seamless integration of data from multiple sources to produce a transaction space and a set of documents posted thereon that are specific to the transaction and satisfy the requirements or all the jurisdictions, localities and participants of the transaction.

As discussed previously, the system can also request that documents be provided by an outside source, such as by one of the participants, and loaded onto the system or, more particularly, onto the secure transaction space. By having the documents loaded onto the system from an outside source, the system need not create them internally. However, by having the documents prepared outside the system, if there are changes to be made in the documents, the documents must be taken off the system, changed off line and then reposted onto the system. In some embodiments, document images can be loaded onto the system such that data can be extracted from the documents, and this may be useful for either of the two rule-based embodiments discussed above.

It is also possible that the system could prepare “documents” entirely on line such that there are no document images actually prepared. In this embodiment, approval to the transaction that is given by participants consists of digital signatures on a set of data or on the transaction space, without there being any requirement for document images to be created or viewed. Thus, once the required information is input into the transaction space, approval of the participants completes the transaction.

With respect to the documents that are either created by or posted onto the secure transaction interface, the system preferably allows a list of controlling properties to be linked to each document. These properties are preferably linked to the document as hidden code and can govern and control the form of the document, the content of the document, the handling of the document or the life cycle of the document. For paper documents, properties can require that signatures of certain participants are required or that those signatures be notarized or witnessed. The properties can also dictate, for example, the size or format of the document or that specific color copies of the executed document get sent to specific parties.

For documents that are created electronically and are executed electronically, the document properties become more critical. As an electronically executable document is created, the set of document properties becomes a tangible adjustment to the document, since data is used both to create and to manage the document. Such document properties can determine and control the format of the document for execution, the nature of the document's execution and how the document may be electronically handled subsequent to execution, such as the lifecycle of the document, disposition and storage of the electronic document, as well as the ownership, retention and final disposition of the electronic document.

The system database also stores information regarding all payments that must be made in order to complete the transaction. The system stores information regarding the various payments that are required by law and custom, according to the different localities or jurisdictions, or even perhaps as a result of certain actions that are taken pursuant to the transaction, such as a title search. The system also stores information regarding the calculations of these payments and regarding the payor participants and payee participants of these payments. For example, certain jurisdictions or participants may require transfer taxes or surcharges, and these payments must be accounted for. The system also considers and calculates portions of payments that must be made within portions of cycle periods, which may affect the payments that are to be made, depending .upon the date upon which the transaction occurs within a particular billing cycle. For example, in real estate transactions, certain tax and utility payments are made by homeowners periodically, in billing cycles, and, if the transaction occurs within a billing cycle, the system calculates the portion of the taxes or payments that must be made by the seller of the property and the portion of the taxes or payments that must be made by the buyer of the property.

Once sufficient information is input into the transaction space, either as a result of the first or second embodiments described above regarding creation of the electronic interface/transaction space, the required payments are calculated and included onto the transaction space and onto the various required or preferred forms. In one embodiment, Deal Manager 190, in the embodiment of FIG. 9, or the Business Services 204 module, in the embodiment of FIG. 10, calculates all tax payment, disbursement and payoff information, as described above, based upon the required payments, banking information, participant requirements and transaction information as input into the transaction space. Funds transfers are then scheduled, using payment and bank information as submitted by the various payor participants and the various payee participants.

Prior to closing of the transaction, all parties are reminded by the system to update all information on the transaction site. All parties that will be initiating payments are reminded to notify their banks to accept electronic wiring instructions or must set up an escrow account prior to the conclusion of the transaction with a company clearing bank partner that accepts such instructions.

An automated system agent is also preferably provided in order to automatically scan the transaction database and notify participants, preferably by fax or e-mail, of any information that is required for closing a transaction that is missing. The system agent scans the transaction database for all open transactions with a settlement date that is within a predetermined amount of time, for example, a month. If the settlement date of a transaction is within the predetermined time, the information entered for that transaction is checked to see whether all the required information is present. If it is not, a list of missing information is distributed to each participant. Preferably, the system agent runs once a day against a subset of open transactions in order to prevent scanning the same transaction every day. Once it is determined that a given transaction is missing required information, that transaction is re-scanned every few days and the participants are re-notified until the required information is supplied.

When notification to a participant is required, some notification text is generated containing a link to the web site or system of the present invention. The notification can be sent by regular postage, e-mail or fax, or another method, depending on the method selected by the participant during the registration process. In the event that some details of a transaction change or must be updated for whatever reason, a participant can update the details of a transaction by logging on, selecting a transaction and selecting the option to update transaction details.

The system can also create a personalized web page for each participant through which all relevant transaction spaces can be accessed. By this personalized display, all active transactions for participants can be accessed by the participants. Displays for individuals will preferably provide information regarding all transactions in which that individual is participating. Displays for professionals will preferably contain two parts: transactions in which the professional himself is participating as an individual, and transactions in which the professional's company is participating. Transactions can be sorted by any of a number of factors, such as property address, loan number, title insurance policy number, agent and settlement date. Once a transaction is selected, the system displays the transaction space showing the transactions details.

At the completion of the transaction, all of the parties either are physically together in one location or are virtually together by some electronic or virtual form of communication, e.g., video conferencing, in order to finalize the transaction. Alternatively, each party may take his or her action on-line, separately and at different times from those of the others, such as by logging into the secure electronic interface that has been created specifically for that particular transaction. First, the participants to the transaction are finalized, and all attendees at the transaction closing are identified. Each participant will preferably enter its ID, password and PIN. The participants then review the information, details and documents of the transaction, including calculations and government-required forms (e.g., HUD forms), review and sign all documents (preferably with digital signature and notarization), finalize fund deposits, authorize transfers of finds and provide wire transfer information and disbursement authorization. The participants then input their final on-line authorization for the closing transactions. Each of the purchaser, seller, their attorneys, the title agent and the lender's attorney must approve all details of the transaction and all the documents and information on the system. All transactions produced are signed and logged. The system can create audit records for the participants to view prior to giving their approval to the transaction.

Before the system will finalize the closing, the system preferably will capture identification of the participants, and any powers of attorney must be identified. The system will require input from a user station of some identity verification, such as a digital or video image, digital signature or some other biometric data, such as a fingerprint or voice identification or the like, of all participants. If the parties have access to a system equipped with the proper hardware, all parties attending the closing are prompted for biometric data, such as fingerprinting, and for digital imaging and signatures. The fingerprint and digital image and signatures are annexed to each party's electronic “approval” record. It is preferable that, once each party locks-in its approval at closing (or prior to closing), the transaction details cannot be modified. If the required digital images and fingerprints cannot be obtained, then Deal Manager 190 can override the requirement. Overriding this requirement causes a signed transaction to be logged and indicates the party that authorized the override. All signing of transactions will preferably employ DSA technology or some other similarly secure digital or other means.

For the completion of the transaction, the system must make all payments and expenses, including taxes, payoffs and disbursements, the calculations of which were discussed above. Each party will authorize only the disposition of its funds, i.e., the buyer authorizes disposition of the down payment and his own cash, the title agent authorizes disposition of taxes and title monies, etc. When all parties lock-in their approval, a chosen participant, such as the title agent, submits the approval to the system. If the passwords and PINs entered by the parties at the closing are correct, the system transmits the wire transfer payment instructions by an electronic payment initiator, such as Fed Wire or ACH, to the clearing banks to transfer the appropriate funds. The clearing bank makes all electronic payments to the pay-off bank, the seller, any other participants, and the various localities for recording fees and transfer taxes. Electronic funds transfers or credit card payments are processed for expenses such as utilities, title company and agent fees, and real estate brokers.

Currently, credit cards are not used at completion of many transactions, such as those for real property in many states. This is primarily due to the fact that the sellers, attorneys and title companies are not credit card “merchants”, set up to receive credit card payments. The system will allow for the purchaser and seller to pay all incidentals with credit/debit cards.

Preferably, the clearing bank permits electronic set up of escrow accounts. As such, the system can redirect a significant portion of the down payment escrow to the clearing banks. The clearing bank will have opportunities to open a new account with the buyer at the time of escrow set up. The bank will also be able to cross sell to other service participants, including lawyers and title companies

After electronic transfer of funds, payment details are recorded, and, once the system alerts the parties that the appropriate wires have been initiated and received, the system generates all required reports and forms, such as confirmations, transaction reports and HUD statements. After completion of the transaction, no action is required from any party other than the transmittal of documents, if desired, and all monies are preferably available immediately in the appropriate accounts. The system can also create audit records for the participants to view and print, to their individual specifications, showing the final details of the completed transaction.

Preferably, the system does not retain any funds. Instead, the system acts merely to facilitate transactions and as an interface to clearing banks that will initiate and confirm electronic payments via the various wire payment transfers. If the system has a sponsoring company, that company will preferably be partnered with clearing banks in order to establish escrow accounts, to electronically initiate transfer payments, and to set up merchant accounts for credit/debit card payments. The sponsoring company may also be entitled to payments from the appropriate parties only upon said parties' authorizations.

Until such time as the Internet is available to all parties and the system can be linked with all participants and their respective funding sources, the system will preferably also allow parties and certain funds transfers to opt out of the system. Although the system tracks the money trail and inputs the off-system transactions on the HUD form and generate various reports at closing, it will still allow for payments to be made by check, if desired.

Thus, a system and method of managing internet-based financial transactions is provided. One skilled in the art will appreciate that the present invention can be carried out in other ways Hi and practiced by other than the described embodiments, yet not departing from the spirit and essential characteristics depicted herein. The present embodiments therefore should be considered in all respects as illustrative, and the present invention is limited only by the claims that follow.

What is claimed is:

1. A system for facilitating a financial transaction among a plurality of participants over an electronic network, comprising:
a processor, and an electronic memory operatively connected thereto;
a set of rules, stored in said electronic memory, containing information regarding the laws of various jurisdictions or localities, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants;
means for accepting into said electronic memory through said electronic network the input of information regarding the transaction and its participants;
means for correlation of said input information regarding the transaction and its participants with said stored rules of information and for deriving from said correlation a subset of rules that are applicable to the transaction and its participants; and
means for presenting to said participants terms of the transaction and documents required for the transaction in specific formats or templates required for the transaction, through said electronic network, based upon said input information regarding the transaction and its participants and said subset of rules that are applicable to the transaction and its participants.

2. The system of claim 1 further comprising calculation means for computing all payments due in the transaction.

3. The system of claim 1 wherein said input information regarding the transaction and its participants comprises information regarding the financial terms of said transaction, said system further comprising electronic payment means for effecting transfer of funds or making payments through said electronic network as a function of said information regarding the financial terms of said transaction.

4. The system of claim 1 wherein said input information regarding the transaction and its participants comprises information regarding the type or location of the transaction, and said set of rules comprises rules that determine terms of the transaction, participants of the transaction or specific types, formats or templates of documents of the transaction based upon the type or location of the transaction.

5. The system of claim 1 wherein:
the transaction is a transaction involving property,
said input information regarding the transaction and its participants comprises information regarding the type and location of said property, and
said set of rules comprises rules that determine terms of the transaction, participants of the transaction or the specific types, formats or templates of documents of the transaction based upon the type and location of said property.

6. The system of claim 1 wherein said input information regarding the transaction and its participants comprises personal or biographical information regarding the participants of the transaction, and said set of rules comprises rules that determine terms of the transaction, participants of the transaction or the specific types, formats or templates of documents of the transaction based upon the identities of the participants of the transaction.

7. The system of claim 1 wherein said input information regarding the transaction and its participants comprises information regarding the role of each participant, said system further comprising means for assigning to each participant a privilege level in accordance with the role of that participant.

8. The system of claim 7 wherein said set of rules comprises rules that determine, based upon the privilege level assigned to each participant, the extent of the presentation to that participant of terms of the transaction and of images of documents in said specific formats or templates relating to the transaction.

9. The system of claim 1 wherein:
said set of rules comprises rules that determine terms of the transaction, participants of the transaction or specific types, formats or templates of documents of the transaction based upon one or more of the type of the transaction, the location of the transaction, the type of the property transacted if the transaction is a transaction involving property, the location of the property transacted if the transaction is a transaction involving property, and the identities of the participants of the transaction, and
said set of rules further comprises a set of conflict rules for resolving conflicts among said rules that determine terms of the transaction or the specific types, formats or templates of documents of the transaction.

10. The system of claim 1 wherein said means for presenting to said participants terms of the transaction and documents required for the transaction in said specific types, formats or templates relating to the transaction comprises an electronic interface specific to the transaction, said electronic interface being accessible through said electronic network and only by transaction participants.

11. The system of claim 10 further comprising means for verification of the identity of the participants of the transaction, wherein said means for verification verifies the identity of each participant prior to allowing said participant access to said electronic interface.

12. The system of claim 10 wherein said documents required for the transaction are presented on said electronic interface as a set of data without any specific images or forms.

13. The system of claim 10 further comprising means for linking to each of said documents a set of document properties that describe or control the form, content or handling of said document.

14. The system of claim 10 wherein:
said input information regarding the transaction and its participants comprises information regarding the role of each participant,
said system further comprising means for assigning to each participant a privilege level in accordance with the role of that participant, and
said set of rules comprises rules that determine, based upon the privilege level assigned to each participant, the selected portions of said electronic interface that are available to that participant or the selected actions that may be taken by that participant with respect to said electronic interface.

15. The system of claim 1 wherein said means for presenting to said participants terms of the transaction and documents required for the transaction in specific formats or templates required for the transaction comprises:
means for determining, based upon said input information regarding the transaction and its participants and based upon said subset of rules that are applicable to the transaction and its participants, the terms of the transaction;
means for determining, based upon said input information regarding the transaction and its participants and based upon said subset of rules that are applicable to the transaction and its participants, the specific document types required for the transaction;
means for determining, based upon said input information regarding the transaction and its participants and based upon said subset of rules that are applicable to the transaction and its participants, the specific document formats or templates required for the transaction;
means for preparing images of documents, of the specific types required for the transaction, in the specific formats or templates required for the transaction, and containing the terms of the transaction; and
means for displaying said images of documents on an electronic interface specific to the transaction and accessible only by transaction participants.

16. The system of claim 1 wherein said set of rules further comprises:
a set of default rules comprising a default set of images of documents in said specific types, formats or templates, and
a set of variation rules comprising information regarding the laws of various jurisdictions, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants, that determine the variations to said default set of images of documents based upon said input information regarding the transaction and its participants.

17. The system of claim 16 wherein said means for presenting to said participants terms of the transaction and images of documents required for the transaction in specific formats or templates required for the transaction comprises:
means for determining, based upon input information regarding the transaction and its participants, the terms of the transaction;
means for determining, based upon said set of default rules, said set of variation rules and said input information regarding the transaction and its participants, the specific document types required for the transaction;
means for determining, based upon said set of default rules, said set of variation rules and said input information regarding the transaction and its participants, the specific document formats or templates required for the transaction;
means for preparing images of documents, of the specific types required for the transaction, in the specific formats or templates required for the transaction, and containing the terms of the transaction; and
means for displaying said images of documents on an electronic interface specific to the transaction and accessible only by transaction participants.

18. The system of claim 16 wherein said means for presenting to said participants terms of the transaction and images of documents required for the transaction in specific formats or templates required for the transaction comprises:
means for determining, based upon input information regarding the transaction and its participants, the terms of the transaction;
means for determining, based upon said set of default rules and said input information regarding the transaction and its participants, the default document types required for the transaction;
means for determining, based upon said set of variation rules and said input information regarding the transaction and its participants, the variations to said default document types required for the transaction;
means for determining, based upon said default document types required for the transaction and said variations to said default document types required for the transaction, the specific document types required for the transaction;
means for determining, based upon said set of default rules and said input information regarding the transaction and its participants, the default document formats or templates required for the transaction;
means for determining, based upon said set of variation rules and said input information regarding the transaction and its participants, the variations to said default document formats or templates required for the transaction;
means for determining, based upon said default document formats or templates required for the transaction and said variations to said default document formats or templates required for the transaction, the specific document formats or templates required for the transaction;
means for preparing images of documents, of the specific types required for the transaction, in the specific formats or templates required for the transaction, and containing the terms of the transaction; and
means for displaying said images of documents on an electronic interface specific to the transaction and accessible only by transaction participants.

19. The system of claim 1 further comprising means for changing said set of rules as said information regarding the laws of various jurisdictions or localities, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants is changed or revised.

20. The system of claim 1 further comprising means for adding new rules to said set of rules as new information regarding the laws of various jurisdictions or localities, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants is acquired.

21. The system of claim 1 further comprising means for creating audit records to permit participants of the transaction to verify terms of the transaction.

22. The system of claim 21 further comprising means for allowing selected of said participants to verify terms of the transaction on said audit records and to indicate electronic approval for completion of the transaction.

23. A method of facilitating a property transaction among a plurality of participants, comprising the steps of:
storing, into an electronic memory, a set of rules containing information regarding the laws of various jurisdictions or localities, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants;
accepting into said electronic memory through said electronic network the input of information regarding the transaction and its participants;
correlating said input information regarding the transaction and its participants with said stored rules of information and deriving therefrom a subset of rules that are applicable to the transaction and its participants; and
presenting to said participants terms of the transaction and documents required for the transaction in specific formats or templates required for the transaction, through said electronic network, based upon said input information regarding the transaction and its participants and said subset of rules that are applicable to the transaction and its participants.

24. The method of claim 23 further comprising the step of computing all payments due in the transaction.

25. The method of claim 23 wherein said step of accepting the input of information regarding the transaction and its participants comprises accepting the input of information regarding the financial terms of said transaction, said method further comprising the step of effecting transfer of funds or making payments through said electronic network as a function of said information regarding the financial terms of said transaction.

26. The method of claim 23 wherein said step of accepting the input of information regarding the transaction and its participants comprises accepting the input of information regarding the type or location of the transaction, and said step of storing a set of rules comprises storing rules that determine terms of the transaction, participants of the transaction or specific types, formats or templates of documents of the transaction based upon the type or location of the transaction.

27. The method of claim 23 wherein said step of accepting the input of information regarding the transaction and its participants comprises accepting the input of information regarding the type or location of said property, and said step of storing a set of rules comprises storing rules that determine terms of the transaction, participants of the transaction or the specific types, formats or templates of documents of the transaction based upon the type or location of said property.

28. The method of claim 23 wherein said step of accepting the input of information regarding the transaction and its participants comprises accepting the input of personal or biographical information regarding the participants of the transaction, and said step of storing a set of rules comprises storing rules that determine terms of the transaction, participants of the transaction or the specific types, formats or templates of documents of the transaction based upon the identities of the participants of the transaction.

29. The method of claim 23 wherein said step of accepting the input of information regarding the transaction and its participants comprises accepting the input of information regarding the role of each participant, said method further comprising the step of assigning to each participant a privilege level in accordance with the role of that participant.

30. The method of claim 29 wherein said step of storing a set of rules comprises storing rules that determine, based upon the privilege level assigned to each participant, the extent of the presentation to that participant of terms of the transaction and of images of documents in said specific formats or templates relating to the transaction.

31. The method of claim 23 wherein:
said step of storing a set of rules comprises storing rules that determine terms of the transaction, participants of the transaction or specific types, formats or templates of documents of the transaction based upon one or more of the type of the transaction, the location of the transaction, the type of the property transacted if the transaction is a transaction involving property, the location of the property transacted if the transaction is a transaction involving property, and the identities of the participants of the transaction, and said step of storing a set of rules further comprises storing a set of conflict rules for resolving conflicts among said rules that determine terms of the transaction or the specific types, formats or templates of documents of the transaction.

32. The method of claim 23 wherein said step of presenting to said participants terms of the transaction and documents required for the transaction in said specific types, formats or templates relating to the transaction comprises providing an electronic interface specific to the transaction, said electronic interface being accessible through said electronic network and only by transaction participants.

33. The method of claim 32 further comprising the step of verifying the identity of each participant of the transaction prior to allowing said participant access to said electronic interface.

34. The method of claim 32 wherein said step of presenting to said participants documents required for the transaction further comprises presenting said documents on said electronic interface as a set of data without any specific images or forms.

35. The method of claim 32 further comprising the step of linking to each of said documents a set of document properties that describe or control the form, content or handling of said document.

36. The method of claim 32 wherein:
said step of accepting the input of information regarding the transaction and its participants comprises accepting the input of information regarding the role of each participant,
said method further comprising the step of assigning to each participant a privilege level in accordance with the role of that participant, and
said step of storing a set of rules further comprises storing rules that determine, based upon the privilege level assigned to each participant, the selected portions of said electronic interface that are available to that participant or the selected actions that may be taken by that participant with respect to said electronic interface.

37. The method of claim 23 wherein said step of presenting to said participants terms of the transaction and documents required for the transaction in specific formats or templates required for the transaction comprises the steps of:
determining, based upon said input information regarding the transaction and its participants and based upon said subset of rules that are applicable to the transaction and its participants, the terms of the transaction;
determining, based upon said input information regarding the transaction and its participants and based upon said subset of rules that are applicable to the transaction and its participants, the specific document types required for the transaction;
determining, based upon said input information regarding the transaction and its participants and based upon said subset of rules that are applicable to the transaction and its participants, the specific document formats or templates required for the transaction;
preparing images of documents, of the specific types required for the transaction, in the specific formats or templates required for the transaction, and containing the terms of the transaction; and
displaying said images of documents on an electronic interface specific to the transaction and accessible only by transaction participants.

38. The method of claim 23 wherein said step of storing a set of rules further comprises the steps of:
storing a set of default rules comprising a default set of images of documents in said specific types, formats or templates, and
storing a set of variation rules comprising information regarding the laws of various jurisdictions, regarding the customs, habits or requirements of professionals and authorities capable of effectuating the transaction in said jurisdictions and of other participants, and regarding the specific document types, formats or templates used by said jurisdictions, said professionals and authorities and said participants, that determine the variations to said default set of images of documents based upon said input information regarding the transaction and its participants.

39. The method of claim 38 wherein said step of presenting to said participants terms of the transaction and images of documents required for the transaction in specific formats or templates required for the transaction comprises the steps of:
determining, based upon input information regarding the transaction and its participants, the terms of the transaction;
determining, based upon said set of default rules, said set of variation rules and said input information regarding the transaction and its participants, the specific document types required for the transaction;
determining, based upon said set of default rules, said set of variation rules and said input information regarding the transaction and its participants, the specific document formats or templates required for the transaction;
preparing images of documents, of the specific types required for the transaction, in the specific formats or templates required for the transaction, and containing the terms of the transaction; and
displaying said images of documents on an electronic interface specific to the transaction and accessible only by transaction participants.

40. The method of claim 38 wherein said step of presenting to said participants terms of the transaction and images of documents required for the transaction in specific formats or templates required for the transaction comprises the steps of:
determining, based upon input information regarding the transaction and its participants, the terms of the transaction;
determining, based upon said set of default rules and said input information regarding the transaction and its participants, the default document types required for the transaction;
determining, based upon said set of variation rules and said input information regarding the transaction and its participants, the variations to said default document types required for the transaction;
determining, based upon said default document types required for the transaction and said variations to said default document types required for the transaction, the specific document types required for the transaction;
determining, based upon said set of default rules and said input information regarding the transaction and its participants, the default document formats or templates required for the transaction;
determining, based upon said set of variation rules and said input information regarding the transaction and its participants, the variations to said default document formats or templates required for the transaction;
determining, based upon said default document formats or templates required for the transaction and said variations to said default document formats or templates required for the transaction, the specific document formats or templates required for the transaction;
preparing images of documents, of the specific types required for the transaction, in the specific formats or templates required for the transaction, and containing the terms of the transaction; and
displaying said images of documents on an electronic interface specific to the transaction and accessible only by transaction participants.

41. The method of claim 23 further comprising the step of changing said set of rules as said information regarding the laws of various jurisdictions or localities, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants is changed or revised.

42. The method of claim 23 further comprising the step of adding new rules to said set of rules as new information regarding the laws of various jurisdictions or localities, regarding the customs, habits or requirements of professionals and authorities capable of effectuating the transaction in said jurisdictions or localities and of other participants, and regarding the specific document types, formats or templates used by said jurisdictions or localities, said professionals and authorities and said participants is acquired.

43. The method of claim 1 further comprising the step of creating audit records to permit participants of the transaction to verify terms of the transaction.

44. The method of claim 43 further comprising the step of allowing selected of said participants to verify terms of the transaction on said audit records and to indicate electronic approval for completion of the transaction.

45. A computer readable medium for use in facilitating a transaction among a plurality of participants, comprising:
a first portion having stored therein a set of data rules regarding the laws of various jurisdictions, regarding the customs, habits or requirements of professionals and authorities capable of effectuating transactions in said jurisdictions, and regarding specific document types, formats or templates used by said jurisdictions, said professionals and authorities and participants of such transactions;
a second portion capable of storing therein data relating to the transaction and its participants; and
a third portion having stored therein computer executable code, wherein, upon execution by a computer of instructions embedded in said code, said data relating to the transaction and its participants is correlated with said set of data rules, and a user interface associated with the computer selectively displays terms of said transaction and displays documents required for the transaction in specific types, formats or templates required for the transaction and its participants.

46. The computer readable medium of claim 45, wherein said executable code further comprises instructions for calculating all payments due pursuant to the transaction based upon said correlation of said data relating to the transaction and its participants with said set of data rules.

47. The computer readable medium of claim 46, wherein said executable code further comprises instructions for effecting all payments due pursuant to the transaction.

48. The computer readable medium of claim 46, wherein said set of data rules further comprises rules that determine terms of the transaction, participants of the transaction or specific types, formats or templates of documents of the transaction based upon one or more of the type of the transaction, the location of the transaction, the type of the property transacted if the transaction involves property, the location of the property transacted if the transaction involves property, and the identities of the participants of the transaction.

49. The computer readable medium of claim 48, wherein said first portion further has stored therein a set of conflict rules for resolving conflicts among said rules that determine terms of the transaction or the specific types, formats or templates of documents of the transaction.

50. The computer readable medium of claim 45, wherein said user interface is specific to the transaction and is accessible to participants of the transaction over an electronic network.

51. The computer readable medium of claim 45, wherein said executable code further comprises instructions for:
extracting, based upon said set of data rules and said data relating to the transaction and its participants, from said set of data rules a subset of data rules applicable to the transaction and its participants;
applying said subset of data rules applicable to the transaction and its participants to said data relating to the transaction and its participants to derive the specific terms of the transaction and the specific documents for the transaction in the specific document types, formats and templates required for the transaction and its participants; and
making said terms of the transaction and said specific documents of the transaction available for display to said participants through said user interface.

52. The computer readable medium of claim 51 further comprising a fourth portion having stored therein a set of default set of terms and a default set of documents in default types, formats or templates, and wherein said set of data rules comprises a set of variation rules that determine the variations to said default set terms and to said default set of documents, based upon said data relating to the transaction and its participants, whereby said executable code applies said set of variation rules to said data relating to the transaction and its participants to derive the specific terms of the transaction and the specific documents for the transaction.

53. A system for monitoring and managing a financial transaction involving a plurality of participants, the system comprising:
a central processor configured to communicate with a plurality of network devices via an electronic network to accept input through said electronic network of information regarding the transaction and its participants;
said processor storing a set of rules containing information regarding the laws of various jurisdictions, regarding the customs, habits or requirements of professionals and authorities capable of effectuating the transaction in said jurisdictions and of other participants, and regarding the specific document types, formats or templates used by said jurisdictions, said professionals and authorities and said participants, each of said rules providing terms or specific types, formats or templates of documents that are appropriate for the transaction based upon information regarding the transaction and its participants input through said electronic network;
said processor capable of integrating said information regarding the transaction and its participants input from said electronic network with said set of rules to derive the actual terms of the transaction and the actual set of documents in specific types, formats or templates used by the relevant jurisdictions, professionals and authorities, and participants expressing the terms of the transaction; and
a graphical user interface system configured to provide a unified graphical user interface to participants of the transaction at said plurality of network devices for expressing the terms of the transaction and for allowing restricted access of said participants to said set of documents.

54. The system of claim 53, wherein said processor further stores a set of conflict rules for resolving conflicts among said set of rules that provide terms or specific types, formats or templates of documents that are appropriate for the transaction, whereby said processor integrates said information regarding the transaction and its participants input from said electronic network with said conflict-resolved set of rules.

55. The system of claim 53, wherein said processor further stores a default set of terms and a default set of documents in default types, formats or templates, and a set of variation rules that determine the variations to said default set of terms and to said default set of documents, based upon said information regarding the transaction and its participants input through said electronic network, whereby said processor integrates said information regarding the transaction and its participants input from said electronic network with said variations to said default set terms and to said default set of documents.

56. The system of claim 53, wherein said graphical user interface system comprises a set of properties codes linked to each document in said set of documents that describe or control the form, content or handling of said document.

57. A graphical user interface for use in managing a financial transaction among participants over an electronic network, said interface associating a central processing device with a plurality of remote computing devices, the graphical interface comprising:
an interactive screen for accepting input of information regarding the transaction and its participants from said remote computing devices;
a routine which
enables a user to input information regarding the transaction and its participants,
permits correlation of said input information with information regarding the laws of various jurisdictions, regarding the customs, habits or requirements of professionals and authorities capable of effectuating the transaction in said jurisdictions and of other participants, and regarding the specific document types, formats or templates used by said jurisdictions, said professionals and authorities and said participants, said correlation providing the actual terms of the transaction and the actual documents of the transaction in specific types, formats or templates that are appropriate for the transaction based upon said input information regarding the transaction and its participants, and
makes said actual terms of the transaction and said actual documents of the transaction available for access by said participants at remote computing devices upon verification of the identity of said participants.

58. The graphical computer interface of claim 57 wherein said interactive screen is specific to the transaction based upon said input information regarding the transaction and its participants.

59. The graphical computer interface of claim 57 wherein said interactive screen is specific to each participant of the transaction based upon said input information regarding the transaction and its participants.

60. The graphical computer interface of claim 57 wherein said routine links to each document in said set of documents a set of properties codes that describe or control the form, content or handling of said document.
